(19) United States
(12) Patent Application Publication
(10) Pub. No.: US 2022/0154768 A1
(43) Pub. Date: May 19, 2022

(54) PLAIN BEARING AND TURBOCHARGER

(71) Applicant: TAIHO KOGYO CO., LTD., Toyota-shi, Aichi (JP)

(72) Inventors: Katsumi NAKAMURA, Toyota-shi, Aichi (JP); Kazunori NAKAYA, Chiryu-shi, Aichi (JP); Kazuma HARADA, Okazaki-shi, Aichi (JP)

(73) Assignee: TAIHO KOGYO CO., LTD., Toyota-shi, Aichi (JP)

(21) Appl. No.: 17/440,225

(22) PCT Filed: Dec. 25, 2019
(86) PCT No.: PCT/JP2019/050830

§ 371 Date: Sep. 17, 2021

(30) Foreign Application Priority Data
Mar. 18, 2019 (JP) 2019-050501

(51) Int. Cl. F16C 33/10; F16C 17/10

(52) U.S. Cl. CPC F16C 33/106; F16C 2360/24; F16C 17/10

(57) ABSTRACT

A plain bearing includes: a bearing body; a radial bearing portion arranged on an inner peripheral surface of the bearing body; a thrust bearing portion arranged on an axial end surface of the bearing body; a damper portion arranged on an outer peripheral surface of the bearing body; a dam portion arranged on the outer peripheral surface of the bearing body; and an oil hole having an inlet that opens to at least one of the outer peripheral surface of the bearing body and the dam portion, and an outlet that opens to the inner peripheral surface of the bearing body. The inlet, at least a part of the dam portion, and the damper portion are arranged in this order from an axially inner side toward an axially outer side. An outlet of an upstream side oil passage is connected to the inlet on a radially outer side.

### TECHNICAL FIELD

The present invention relates to a plain bearing that supports radial and thrust loads and a turbocharger.

### BACKGROUND ART

Patent Document 1 discloses a turbocharger including a plain bearing. The plain bearing includes a radial bearing portion, a thrust bearing portion, and a pair of damper portions. The radial bearing portion is arranged on the inner peripheral surface of the plain bearing. The thrust bearing portion is arranged on the axial end surface of the plain bearing. The pair of damper portions are arranged at respective axial ends of the outer peripheral surface of the plain bearing. The plain bearing is provided with an oil hole extending in the radial direction. The inlet of the oil hole opens at a position directly above the outer peripheral surface (between the pair of damper portions) of the plain bearing. The outlet of the oil hole opens to the inner peripheral surface of the plain bearing.

The outlet of an oil hole of a housing opens above the inlet of the oil hole. Lubricating oil that flows out from the outlet is diverted to an outer diameter side oil passage (oil passage that passes through the damper portion) and an inner diameter side oil passage (oil passage that passes through the oil hole of the plain bearing and the radial bearing portion) of the plain bearing.
[Patent Document 1] U.S. Pat. No. 7,670,056B2

### SUMMARY OF THE INVENTION

### Problem to be Solved by the Invention

Here, a centrifugal force of a shaft of the turbocharger acts on the thrust bearing portion. Therefore, in the thrust bearing portion, the lubricating oil tends to flow from a radially inner side toward a radially outer side. Therefore, the lubricating oil via the outer diameter side oil passage does not easily flow into the thrust bearing portion. On the contrary, the lubricating oil via the inner diameter side oil passage easily flows into the thrust bearing portion.

However, in the case of the plain bearing described in the same document, the inlet of the oil hole of the plain bearing and the outlet of the oil hole of the housing are arranged so as to be displaced in the axial direction by the radius of the outlet. Therefore, about the same amount of lubricating oil as that of the inner diameter side oil passage is also distributed to the outer diameter side oil passage. Accordingly, it is difficult to supply the lubricating oil to the thrust bearing portion.

On the basis of the above, an object of the present invention is to provide a plain bearing and a turbocharger in which lubricating oil is easily supplied to the thrust bearing portion.

### Means for Solving the Problem

In order to solve the above task, a plain bearing according to the present invention is characterized by including: a cylindrical bearing body; a radial bearing portion arranged on an inner peripheral surface of the bearing body; a thrust bearing portion arranged on an axial end surface of the bearing body; a damper portion arranged on an outer peripheral surface of the bearing body; a dam portion arranged on the outer peripheral surface of the bearing body; and an oil hole having an inlet that opens to at least one of the outer peripheral surface of the bearing body and the dam portion, and an outlet that opens to the inner peripheral surface of the bearing body. The inlet of the oil hole, at least a part of the dam portion, and the damper portion are arranged in this order from an axially inner side toward an axially outer side. The outlet of an upstream side oil passage is connected to the inlet of the oil hole on a radially outer side. The axially outer end of the outlet of the upstream side oil passage is arranged at the axially same position as an axially outer end of the dam portion, or arranged on an axially inner side with respect to the axially outer end of the dam portion. Further, in order to solve the above task, the turbocharger according to the present invention is characterized by including the plain bearing.

### Effects of the Invention

An inlet of an oil hole, at least a part of a dam portion, and a damper portion are arranged in this order from an axially inner side toward an axially outer side. Further, an axially outer end of an outlet of an upstream side oil passage is arranged at the axially same position as an axially outer end of the dam portion. Further, the axially outer end of the outlet of the upstream side oil passage is arranged on an axially inner side with respect to the axially outer end of the dam portion. Therefore, a lubricating oil flowing out from the outlet of the upstream side oil passage can be preferentially introduced into the inlet of the oil hole. That is, the lubricating oil can be preferentially supplied to a thrust bearing portion from an inner diameter side of a bearing body. Therefore, according to the plain bearing and the turbocharger of the present invention, the lubricating oil is easily supplied to the thrust bearing portion.

### BRIEF DESCRIPTION OF THE DRAWINGS

FIG. 1 shows an axial sectional view of a turbocharger according to a mode.

FIG. 2 shows an enlarged view of a portion in the frame II shown in FIG. 1.

FIG. 3 shows an enlarged view of a portion in the frame III shown in FIG. 2.

FIG. 4A shows a sectional view taken along the IVA-IVA direction shown in FIG. 2. FIG. 4B shows a sectional view taken along the IVB-IVB direction shown in FIG. 4A.

FIG. 5 is a perspective view of a plain bearing included in the turbocharger.

FIG. 6 shows an axial sectional view of the plain bearing.

FIG. 7 shows a perspective view of a plain bearing of a first other mode.

FIG. 8 shows a perspective view of a plain bearing of a second other mode.

FIG. 9 shows a perspective view of a plain bearing of a third other mode.

FIG. 10 shows an axial partial sectional view of a plain bearing of a fourth other mode.

### MODES FOR CARRYING OUT THE INVENTION

Hereinafter, a mode for carrying out a plain bearing and a turbocharger according to the present invention will be described.

<Configuration of Turbocharger>

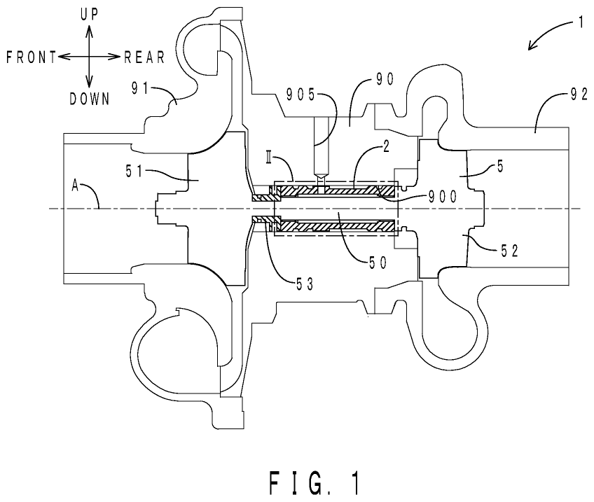

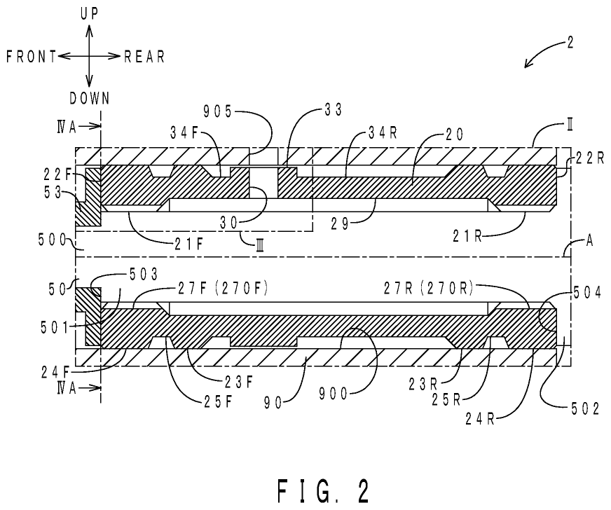

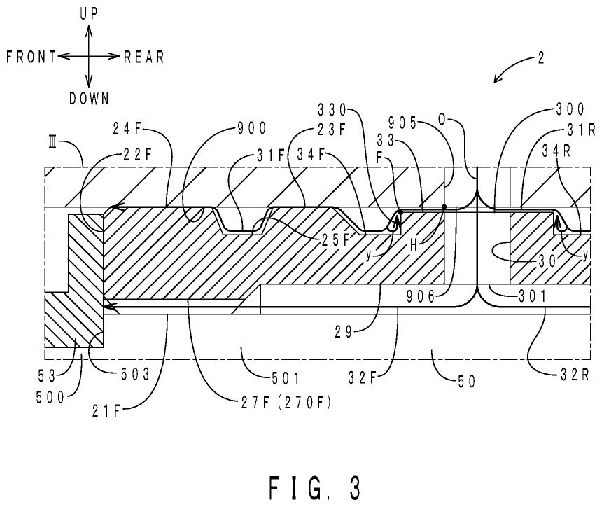

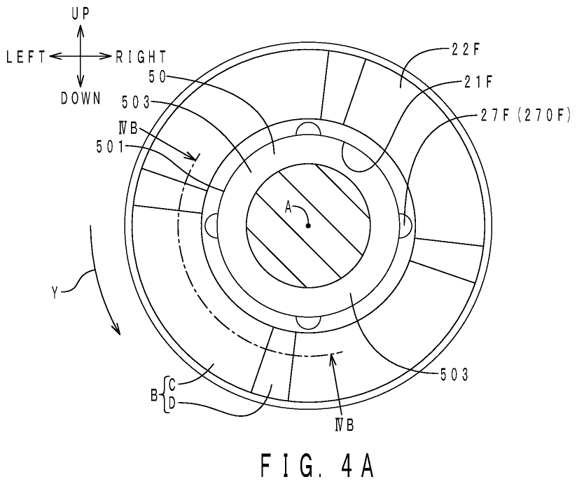

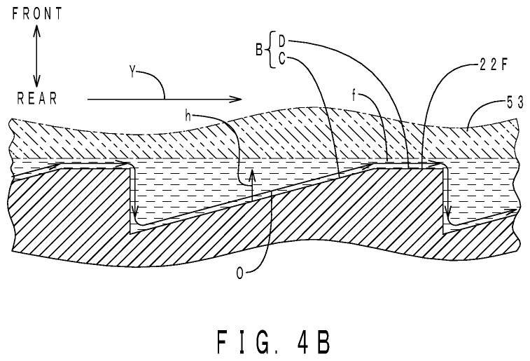

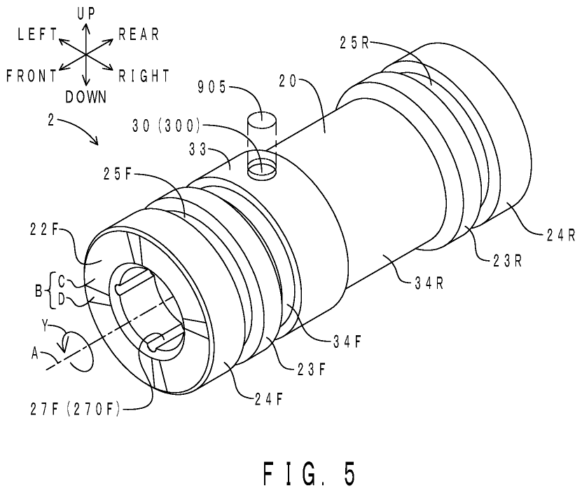

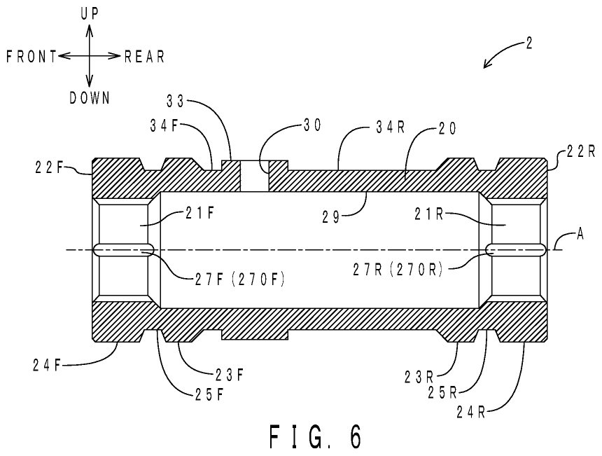

First, the configuration of the turbocharger according to the present mode will be described. In the following drawings, the front-rear direction corresponds to the “axial direction” of the present invention. FIG. 1 shows an axial sectional view of the turbocharger according to the present mode. FIG. 2 shows an enlarged view of a portion in the frame II shown in FIG. 1. FIG. 3 shows an enlarged view of a portion in the frame III shown in FIG. 2. FIG. 4A shows a sectional view taken along the IVA-IVA direction shown in FIG. 2. FIG. 4B shows a sectional view taken along the IVB-IVB direction shown in FIG. 4A. FIG. 5 shows a perspective view of the plain bearing according to the present mode. FIG. 6 shows an axial sectional view of the plain bearing.

A turbocharger 1 includes a plain bearing 2, a rotating portion 5, a bearing housing 90, a compressor housing 91, and a turbine housing 92. A bearing arrangement portion 900 and a housing side oil passage 905 are formed inside the bearing housing 90. The housing side oil passage 905 is included in the concept of an “upstream side oil passage” of the present invention. Lubricating oil O is flowing through the housing side oil passage 905. The bearing arrangement portion 900 is connected to the lower side of the housing side oil passage 905. The bearing arrangement portion 900 extends in the front-rear direction.

The rotating portion 5 is rotatable with respect to the bearing housing 90. The rotating portion 5 includes a rotating shaft 50, a compressor impeller 51, a turbine impeller 52, and a thrust collar 53. The rotating shaft 50 penetrates the bearing housing 90 in the front-rear direction. The rotating shaft 50 has a stepped columnar shape centered on an axis A. The rotating shaft 50 is rotatable supported by a plain bearing 2 that will be described later from the radially outer side. Further, the rotating shaft 50 is rotatable supported by the plain bearing 2 from the front-rear direction. The compressor impeller 51 is attached to the front end (axial one end) of the rotating shaft 50. The turbine impeller 52 is connected to the rear end (the axial other end) of the rotating shaft 50. That is, the rotating shaft 50 connects the compressor impeller 51 and the turbine impeller 52. The thrust collar 53 is fixed to an outer peripheral surface of the rotating shaft 50. The thrust collar 53 is rotatable supported by the plain bearing 2 from the rear side.

<Configuration in Proximity of Bearing Arrangement Portion>

Next, the configuration in proximity of the bearing arrangement portion will be described in detail. The thrust collar 53, the plain bearing 2, and a part of the rotating shaft 50 are arranged in the bearing arrangement portion 900. The rotating shaft 50 includes a small diameter portion 500, a medium diameter portion 501, and a large diameter portion 502 from the front side to the rear side. The medium diameter portion 501 has a larger diameter than that of the small diameter portion 500. A first stepped portion 503 that has an annular shape and faces forward is arranged between the small diameter portion 500 and the medium diameter portion 501. The large diameter portion 502 has a larger diameter than that of the medium diameter portion 501. A second stepped portion 504 that has an annular shape and faces forward is arranged between the medium diameter portion 501 and the large diameter portion 502. The thrust collar 53 is annular and is fit to the small diameter portion 500 in an annular manner. The rear end surface (portion on the radially inner side) of the thrust collar 53 is in contact with the first stepped portion 503.

(Plain Bearing 2)

The plain bearing 2 is fitted to the medium diameter portion 501 in an annular manner. The plain bearing 2 is arranged between the first stepped portion 503 (thrust collar 53) and the second stepped portion 504. The plain bearing 2 includes a bearing body 20, a pair of front and rear radial bearing portions 21F, 21R, a pair of front and rear thrust bearing portions 22F, 22R, a pair of front and rear first damper portions 23F, 23R, a pair of front and rear second damper portions 24F, 24R, a pair of front and rear first groove portions 34F, 34R, a pair of front and rear second groove portions 25F, 25R, a pair of front and rear oil groove groups 27F, 27R, an inner diameter side recess 29, an oil hole 30, a dam portion 33, a pair of front and rear outer diameter side oil passages 31F, 31R, and a pair of front and rear inner diameter side oil passages 32F, 32R. The first damper portions 23F, 23R and the second damper portions 24F, 24R are included in the concept of a “damper portion” of the present invention. The first groove portions 34F, 34R are included in the concept of a “groove portion” of the present invention.

(Bearing Body 20 and Radial Bearing Portions 21F, 21R)

The bearing body 20 is arranged in the bearing arrangement portion 900. The bearing body 20 extends in the front-rear direction. The bearing body 20 has a cylindrical shape centered on the axis A. The pair of front and rear radial bearing portions 21F, 21R are arranged at respective ends of the inner peripheral surface of the bearing body 20 in the front-rear-direction. The pair of front and rear radial bearing portions 21F, 21R are each in sliding contact with the medium diameter portion 501 over the entire circumference (however, except for oil grooves 270F, 270R described later) via an oil film.

(Thrust Bearing Portions 22F, 22R)

The pair of front and rear thrust bearing portions 22F, 22R are arranged on the respective end surfaces (axial end surfaces) of the bearing body 20 in the front-rear direction. The thrust bearing portion 22F on the front side is in sliding contact with the rear end surface (portion on the radially outer side) of the thrust collar 53 over the entire circumference via an oil film f. The thrust bearing portion 22F on the front side includes four pad portions B. The four pad portions B are continuously provided in the circumferential direction. The pad portion B includes a tapered portion C and a land portion D. In FIGS. 4A, 4B, and 5, the flow direction of the lubricating oil O in the thrust bearing portion 22F is indicated by an arrow Y. In FIG. 4B, the thrust collar 53 is shown by long dashed short dashed lines. As shown in an exaggerated manner in FIG. 4B, the tapered portion C has an planar shape in which an altitude h (specifically, an altitude in the front-rear direction; hereinafter the same applies) increases from the upstream side (the rear side in the rotation direction of the rotating shaft 50) toward the downstream side (the front side in the rotation direction of the rotating shaft 50). The land portion D is connected to the downstream side of the tapered portion C. The land portion D has a planar shape in which the altitude h is constant.

The thrust bearing portion 22R on the rear side is in sliding contact with the second stepped portion 504 over the entire circumference via an oil film. The thrust bearing portion 22R on the rear side includes four pad portions as in the thrust bearing portion 22F on the front side.

(Dam Portion 33, First Damper Portions 23F, 23R, Second Damper Portions 24F, 24R)

The dam portion 33 is arranged on the outer peripheral surface of the bearing body 20. As will be described later, an inlet 300 of the oil hole 30 is provided at the center of the dam portion 33 in the front-rear direction. An outlet 906 of the housing side oil passage 905 is connected immediately above the inlet 300 (on the radially outer side).

A front end (axially outer end) H of the outlet 906 is arranged on the rear side (axially inner side) with respect to a front end (axially outer end) F of the dam portion 33. Similarly, a rear end (axially outer end) of the outlet 906 is arranged on the front side (axially inner side) with respect to a rear end (axially outer end) of the dam portion 33. That is, when viewed from directly above, the outlet 906 is arranged so as to be included in the dam portion 33. The dam portion 33 (excluding the opening of the inlet 300) is in contact with the bearing arrangement portion 900 over the entire circumference via an oil film.

The pair of front and rear first damper portions 23F, 23R are arranged on the outer peripheral surface of the bearing body 20. The first damper portion 23F on the front side is arranged on the front side of the dam portion 33 (on the axially outer side (specifically, on the axially outer side when the position of an hole axis of the oil hole 30 in the front-rear direction is set as an axial reference position)). The first damper portion 23R on the rear side is arranged on the rear side (on the axially outer side) of the dam portion 33. The pair of front and rear first damper portions 23F, 23R are each in contact with the bearing arrangement portion 900 over the entire circumference via an oil film.

The pair of front and rear second damper portions 24F, 24R are arranged on the outer peripheral surface of the bearing body 20. The second damper portion 24F on the front side is arranged on the front side of the first damper portion 23F. The second damper portion 24R on the rear side is arranged on the rear side of the first damper portion 23R. The pair of front and rear second damper portions 24F, 24R are each in contact with the bearing arrangement portion 900 over the entire circumference via an oil film. The first damper portions 23F, 23R and the second damper portions 24F, 24R have a function of suppressing a vibration of the rotating shaft 50 of the turbocharger 1 through the oil film.

As described above, the inlet 300, a part of the dam portion 33 (the outer portion of the inlet 300 in the front-rear direction), the first damper portions 23F, 23R, and the second damper portions 24F, 24R are arranged in this order from the axially inner side toward the axially outer side.

(First Groove Portions 34F, 34R and Second Groove Portions 25F, 25R)

The pair of front and rear first groove portions 34F, 34R are arranged on the outer peripheral surface of the bearing body 20. The first groove portion 34F on the front side has an endless ring shape and is arranged between the dam portion 33 and the first damper portion 23F. The first groove portion 34R on the rear side has an endless ring shape and is arranged between the dam portion 33 and the first damper portion 23R. The first groove portions 34F, 34R have a smaller diameter than those of the dam portion 33, the first damper portions 23F, 23R, and the second damper portions 24F, 24R.

The pair of front and rear second groove portions 25F, 25R are arranged on the outer peripheral surface of the bearing body 20. The second groove portion 25F on the front side has an endless ring shape and is arranged between the first damper portion 23F and the second damper portion 24F. The second groove portion 25R on the rear side has an endless ring shape and is arranged between the first damper portion 23R and the second damper portion 24R. The second groove portions 25F, 25R have a smaller diameter than those of the dam portion 33, the first damper portions 23F, 23R, and the second damper portions 24F, 24R.

(Oil Groove Groups 27F, 27R)

The oil groove group 27F on the front side includes four oil grooves 270F. The four oil grooves 270F are arranged apart from each other by 90 degrees with the axis A as the center when viewed from the front side. The oil grooves 270F each penetrate, in the front-rear direction, the radial bearing portion 21F on the front side. The oil groove group 27R on the rear side includes four oil grooves 270R. The four oil grooves 270R are arranged apart from each other by 90 degrees with the axis A as the center when viewed from the front side. The oil grooves 270R each penetrate, in the front-rear direction, the radial bearing portion 21R on the rear side.

(Inner Diameter Side Recess 29, Oil Hole 30)

The inner diameter side recess 29 is arranged on the inner peripheral surface of the bearing body 20 over the entire circumference. The inner diameter side recess 29 is arranged between the pair of front and rear radial bearing portions 21F, 21R. The inner diameter side recess 29 has a larger diameter than those of the radial bearing portions 21F, 21R. The inner diameter side recess 29 is not in contact with the medium diameter portion 501. That is, a clearance is defined between the inner diameter side recess 29 and the medium diameter portion 501.

The oil hole 30 penetrates the bearing body 20 in the radial direction. The oil hole 30 includes the inlet 300 and an outlet 301. As described above, the inlet 300 opens to the dam portion 33. The outlet 301 opens to the inner diameter side recess 29.

(Outer Diameter Side Oil Passages 31F, 31R)

The outer diameter side oil passage 31F on the front side is arranged between the outlet 906 of the housing side oil passage 905 and the thrust bearing portion 22F on the front side. The outer diameter side oil passage 31F includes a part of the dam portion 33 (the portion of the inlet 300 on the forward outer side), the first groove portion 34F, the first damper portion 23F, the second groove portion 25F, and the second damper portion 24F. The outer diameter side oil passage 31R on the rear side is arranged between the outlet 906 of the housing side oil passage 905 and the thrust bearing portion 22R on the rear side. The outer diameter side oil passage 31R on the rear side is the same as the outer diameter side oil passage 31F on the front side.

(Inner Diameter Side Oil Passages 32F, 32R)

The inner diameter side oil passage 32F on the front side is arranged between the outlet 906 of the housing side oil passage 905 and the thrust bearing portion 22F on the front side. The inner diameter side oil passage 32F includes the oil hole 30, the inner diameter side recess 29, and the oil grooves 270F (radial bearing portion 21F). The inner diameter side oil passage 32R on the rear side is arranged between the outlet 906 of the housing side oil passage 905 and the thrust bearing portion 22R on the rear side. The inner diameter side oil passage 32R on the rear side is the same as the inner diameter side oil passage 32F on the front side.

<Flow of Lubricating Oil>

Next, the flow of the lubricating oil in the plain bearing according to the present mode will be described. When the turbocharger 1 is driven, the lubricating oil O is diverted from the housing side oil passage 905 into the pair of front and rear outer diameter side oil passages 31F, 31R and the pair of front and rear inner diameter side oil passages 32F, 32R.

In the outer diameter side oil passage 31F on the front side, the lubricating oil O flows through the dam portion 33, the first groove portion 34F, the first damper portion 23F, the second groove portion 25F, and the second damper portion 24F. The flow of the lubricating oil O in the outer diameter side oil passage 31R on the rear side is the same as the flow of the lubricating oil O in the outer diameter side oil passage 31F on the front side.

In the inner diameter side oil passage 32F on the front side, the lubricating oil O flows through the oil hole 30, the inner diameter side recess 29, the radial bearing portion 21F (the oil grooves 270F), and the thrust bearing portion 22F. The lubricating oil O forms an oil film having a desired load capacity in the radial bearing portion 21F. The radial bearing portion 21F supports the radial load acting on the rotating shaft 50 using the oil film. Further, the lubricating oil O forms an oil film f having a desired load capacity in the thrust bearing portion 22F. Specifically, the pressure of the lubricating oil O is increased when the lubricating oil O flows in tapered portion C, and the oil film f having a desired load capacity is formed in the land portion D. The thrust bearing portion 22F supports the thrust load acting on the rotating shaft 50 using the oil film f. The flow of the lubricating oil O in the inner diameter side oil passage 32R on the rear side is the same as the flow of the lubricating oil O in the inner diameter side oil passage 32F on the front side.

<Action and Effect>

Next, the action and effect of the plain bearing and the turbocharger according to the present mode will be described. Hereinafter, the action and effect of the front side portion of the plain bearing with respect to the axial reference position of the plain bearing 2 (the hole axis position of the oil hole 30) will be described. The same applies to the rear side portion.

As shown in FIG. 3, the centrifugal force of the thrust collar 53 (rotating portion 5) acts on the thrust bearing portion 22F. Therefore, in the thrust bearing portion 22F, the lubricating oil O tends to flow from the radially inner side to the radially outer side. Therefore, the lubricating oil O via the outer diameter side oil passage 31F does not easily flow into the thrust bearing portion 22F. On the contrary, the lubricating oil O via the inner diameter side oil passage 32F easily flows into the thrust bearing portion 22F. Therefore, when the plain bearing 2 does not include the dam portion 33, it is difficult to supply the lubricating oil O to the thrust bearing portion 22F. In order to secure a desired amount of oil in the thrust bearing portion 22F, that is, the inner diameter side oil passage 32F, it is necessary to increase the oil amount (the hydraulic pressure) of the entire oil passages (the outer diameter side oil passage 31F and the inner diameter side oil passage 32F). In this case, the amount of oil in the outer diameter side oil passage 31F becomes excessive.

In this respect, the plain bearing 2 includes the dam portion 33. Therefore, the lubricating oil O flowing out from the outlet 906 of the housing side oil passage 905 can be preferentially introduced into the inlet 300 of the oil hole 30. In other words, the lubricating oil O can be preferentially distributed to the inner diameter side oil passage 32F with respect to the outer diameter side oil passage 31F. Therefore, the lubricating oil O can be preferentially supplied from the inner diameter side oil passage 32F to the thrust bearing portion 22F. Therefore, according to the plain bearing 2 and the turbocharger 1 of the present mode, the lubricating oil O is easily supplied to the thrust bearing portion 22F. Further, in order to increase the amount of oil in the inner diameter side oil passage 32F, it is not necessary to increase the amount of oil in the entire oil passages.

Further, depending on the type of the turbocharger 1, there may be a case where an outer diameter side clearance (a clearance between the first damper portion 23F, the second damper portion 24F and the bearing arrangement portion 900) is larger than an inner diameter side clearance (a clearance between the radial bearing portion 21F and the rotating shaft 50). In this case, the flow rate of the lubricating oil O tends to be higher in the outer diameter side oil passage 31F than in the inner diameter side oil passage 32F. However, due to the action of the centrifugal force of the thrust collar 53 (rotating portion 5), the lubricating oil O in the outer diameter side oil passage 31F is difficult to flow into the thrust bearing portion 22F compared with the lubricating oil O in the inner diameter side oil passage 32F.

In this respect, the plain bearing 2 includes the dam portion 33. Therefore, even with the type of turbocharger 1 in which the outer diameter side clearance is larger than the inner diameter side clearance, the lubricating oil O flowing out from the outlet 906 of the housing side oil passage 905 can be preferentially introduced to the inlet 300 of the oil hole 30.

Further, if the front end H of the outlet 906 of the housing side oil passage 905 shown in FIG. 3 is arranged on the front side with respect to the front end F of the dam portion 33, at least a part of the lubricating oil O flowing out from the outlet 906 flows directly into the first groove portion 34F without passing through the dam portion 33. Therefore, the amount of the lubricating oil O distributed to the inner diameter side oil passage 32F is reduced.

In this respect, the front end H of the outlet 906 of the housing side oil passage 905 is arranged on the rear side with respect to the front end F of the dam portion 33. Therefore, the lubricating oil O flowing out from the outlet 906 cannot flow into the first groove portion 34F unless the lubricating oil O passes through the dam portion 33. Accordingly, the lubricating oil O flowing out from the outlet 906 can be preferentially introduced into the inlet 300 of the oil hole 30. Consequently, the amount of lubricating oil O distributed to the inner diameter side oil passage 32F is unlikely to be reduced.

Further, the flow passage sectional area of the oil hole 30 (sectional area of the oil hole 30 in the direction orthogonal (horizontal direction) to the hole axis direction (up-down direction)) is larger than the flow passage sectional area of a clearance between the dam portion 33 and the bearing arrangement portion 900 (sectional area in the direction orthogonal (perpendicular direction) to the extending direction (front-rear direction) of the clearance). Also in this respect, the lubricating oil O flowing out from the outlet 906 of the housing side oil passage 905 can be preferentially introduced into the inlet 300 of the oil hole 30.

As shown in FIG. 5, the dam portion 33 has an annular shape centered on the axis A of the bearing body 20. Therefore, the dam portion 33 can be easily arranged on the plain bearing 2 by, for example, cutting.

As shown in FIG. 3, the first groove portion 34F is arranged between the first damper portion 23F and the dam portion 33. Further, the first groove portion 34F has a smaller diameter than those of the first damper portion 23F and the dam portion 33. Therefore, when the turbocharger 1 is stopped, the lubricating oil O can be stored in the first groove portion 34F. Accordingly, the stored lubricating oil O can be quickly supplied to the first damper portion 23F and the second damper portion 24F when the turbocharger 1 is restarted. As described above, the first groove portion 34F has a function as an oil sump portion capable of storing the lubricating oil O. Similarly, the second groove portion 25F and the inner diameter side recess 29 also have a function as an oil sump portion capable of storing the lubricating oil O.

As shown in FIG. 4A, the outlet of the oil groove 270F opens on the radially inner side of the upstream end of each of the four tapered portions C. Therefore, when the lubricating oil O flows through the tapered portion C, the pressure of lubricating oil O is easily increased. Further, due to the centrifugal force of the thrust collar 53 (rotating portion 5) shown in FIG. 3, the lubricating oil O easily spreads over the entire thrust bearing portion 22F in the radial direction.

As shown in FIG. 3, a side surface of the dam portion 33 (the groove side surface of the first groove portion 34F on the rear side) 330 extends in the radial direction (up-down direction in FIG. 3) of the plain bearing 2. Therefore, as shown by the arrow y, the flow of the lubricating oil O is likely to be disturbed. Accordingly, the flow of the lubricating oil O in the first groove portion 34F, that is, in the outer diameter side oil passage 31F can be suppressed. Further, the lubricating oil O tends to stay in the first groove portion 34F.

As shown in FIG. 2, the plain bearing 2 includes both the radial bearing portions 21F, 21R and the thrust bearing portions 22F, 22R. Therefore, the number of parts of the turbocharger 1 can be reduced as compared with the case where the turbocharger 1 is provided with the radial bearing and the thrust bearing independently. Further, the configuration of the turbocharger 1 can be simplified. Further, the configuration of the turbocharger 1 can be downsized.

<Others>

The mode for carrying out the plain bearing and the turbocharger according to the present invention has been described as above. However, the mode is not particularly limited to the above mode. It is also possible to carry out the present invention in various modified modes and improved modes that can be performed by those skilled in the art. Hereinafter, the mode for carrying out the front side portion of the plain bearing with respect to the axial reference position of the plain bearing (the hole axis position of the oil hole) will be described. The same applies to the rear side portion.

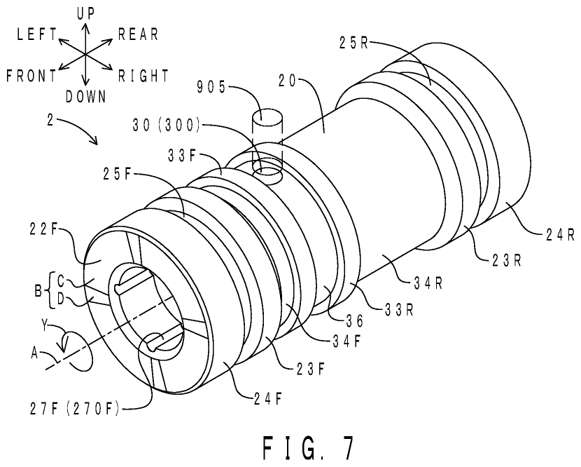

FIG. 7 shows a perspective view of the plain bearing of a first other mode. The components corresponding to the components shown in FIG. 5 are indicated by the same reference numerals. As shown in FIG. 7, the inlet 300 of the oil hole 30 is provided to open in an annular third groove portion 36 (on the outer peripheral surface of the bearing body 20). Dam portions 33F, 33R are arranged on respective outer sides of the oil hole 30 in the front-rear direction. As in the present mode, the inlet 300 may be provided to open in the third groove portion 36 having a diameter smaller than those of the dam portions 33F, 33R. When the turbocharger 1 is stopped, the third groove portion 36 functions as an oil sump portion for storing the lubricating oil O. Therefore, the stored lubricating oil O can be quickly supplied to the outer diameter side oil passage 31F and the inner diameter side oil passage 32F (see FIG. 3) when the turbocharger 1 is restarted.

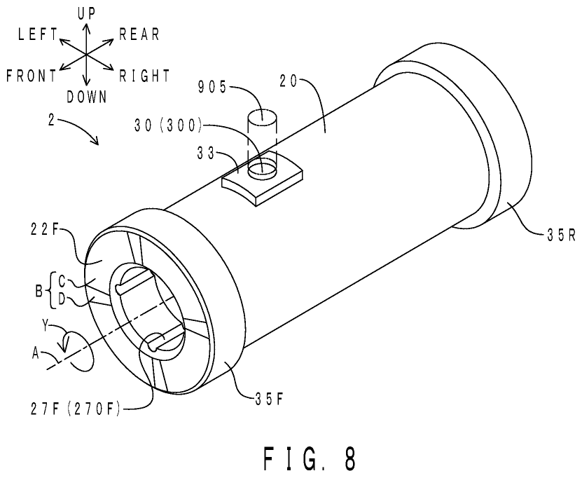

FIG. 8 shows a perspective view of the plain bearing of a second other mode. The components corresponding to the components shown in FIG. 5 are indicated by the same reference numerals. As shown in FIG. 8, the dam portion 33 has a block shape (individual piece shape). The dam portion 33 is locally arranged only in the area of the outer peripheral surface of the bearing body 20 including the inlet 300 of the oil hole 30. The dam portion 33 has a smaller diameter than those of damper portions 35F, 35R (maximum outer diameter portion of the plain bearing 2) of the plain bearing 2 (the dam portion 33 may have the same diameter as the diameter of the maximum outer diameter portion). Therefore, the plain bearing 2 can be easily inserted into the bearing arrangement portion 900 from the front-rear direction. As in the present mode, the dam portion 33 does not have to have an annular shape (endless annular shape) centered on the axis A. Further, the dam portion 33 may have an annular shape surrounding the inlet 300. Further, a pair of the front and rear damper portions 35F, 35R may be arranged.

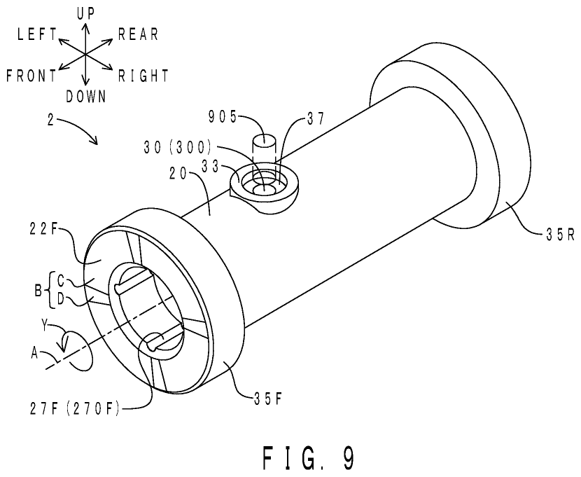

FIG. 9 shows a perspective view of the plain bearing of a third other mode. The components corresponding to the components shown in FIG. 8 are indicated by the same reference numerals. As shown in FIG. 9, the inlet 300 of the oil hole 30 is provided to open in a recess 37 (on the outer peripheral surface of the bearing body 20). The dam portion 33 having an annular shape is arranged around the recess 37. The dam portion 33 surrounds the inlet 300 of the oil hole 30 and the recess 37. The dam portion 33 has a smaller diameter than those of damper portions 35F, 35R (maximum outer diameter portion of the plain bearing 2) of the plain bearing 2 (the dam portion 33 may have the same diameter as the diameter of the maximum outer diameter portion). Therefore, the plain bearing 2 can be easily inserted into the bearing arrangement portion 900 from the front-rear direction. As in the present mode, the dam portion 33 may be locally arranged only around the inlet 300 (only in the minimum necessary range). Further, the recess 37 may be arranged between the inlet 300 and the dam portion 33. When the turbocharger 1 is stopped, the recess 37 functions as an oil sump portion for storing the lubricating oil O. Therefore, the stored lubricating oil O can be quickly supplied to the outer diameter side oil passage 31F and the inner diameter side oil passage 32F (see FIG. 3) when the turbocharger 1 is restarted.

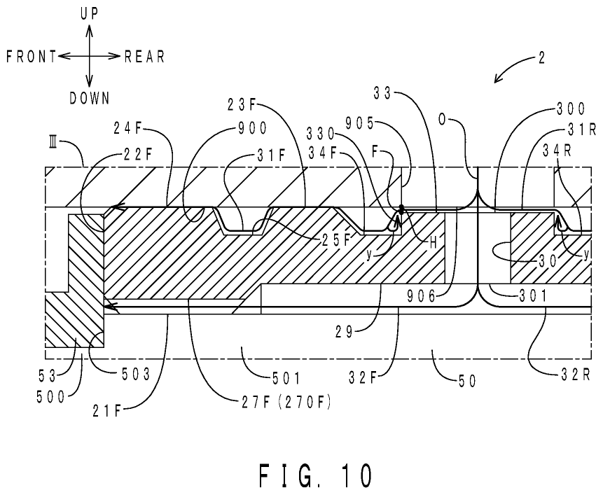

FIG. 10 shows an axial partial sectional view of the plain bearing of a fourth other mode. The components corresponding to the components shown in FIG. 3 are indicated by the same reference numerals. As shown in FIG. 10, the front end H of the outlet 906 of the housing side oil passage 905 is arranged at the same position as the front end F of the dam portion 33 in the front-rear direction. Also in this case, the lubricating oil O flowing out from the outlet 906 of the housing side oil passage 905 can be preferentially introduced into the inlet 300 of the oil hole 30.

The arranged number, shape, and position of the dam portion 33 shown in FIG. 3 are not particularly limited. For example, the dam portion 33 may be an endless ring or an ended ring. Further, the dam portion 33 may be used as a damper portion. The shapes of the tapered portion C and the land portion D shown in FIGS. 4A and 4B, the arranged number of pad portions B, and the like are not particularly limited. The pad portion B may not necessarily be disposed on at least one of the thrust bearing portions 22F, 22R.

The arranged number of the oil grooves 270F shown in FIGS. 4A and 5 is not particularly limited. The arranged number of the oil grooves 270F and the arranged number of the pad portions B may be the same or different from each other. The shape of each oil groove 270F in the longitudinal direction is not particularly limited. The shape of the oil groove 270F in the longitudinal direction may be linear, curved, or a combination of these as appropriate. The cross-sectional shape of each oil groove 270F is not particularly limited. The cross-sectional shape of the oil groove 270F may be a perfect circle, an ellipse, a polygon (triangle, quadrangle, hexagon, etc.), etc. The outlet may be displaced to the downstream side with respect to the inlet when viewed from the front side (the axial direction). With the configuration above, the lubricating oil O is easily drawn into the oil groove 270F by the centrifugal force of the thrust collar 53 (rotating portion 5). Further, the lubricating oil O is easily drawn into the thrust bearing portion 22F. Similar to the oil groove 270F, the arranged number, shape in the longitudinal direction, and cross-sectional shape of the oil hole 30 are not particularly limited.

The arranged number, shapes, and positions of the damper portions (the first damper portion 23F, the second damper portion 24F, the damper portions 35F, 35R) and the groove portions (the first groove portion 34F, the second groove portion 25F) are not particularly limited. For example, the damper portions and the groove portions may be an endless ring or an ended ring. Similarly, the numbers, shapes, and positions of the third groove portion 36 shown in FIG. 7 and the recess 37 shown in FIG. 9 are not particularly limited.

The inlet 300 of the oil hole 30 may open only in the dam portion 33, may open only on the outer peripheral surface of the bearing body 20, or may open across the dam portion 33 and the outer peripheral surface of the bearing body 20. That is, the inlet 300 may open to at least one of the outer peripheral surface of the bearing body 20 (specifically, a portion of the outer peripheral surface of the bearing body 20 where the dam portion 33 is not arranged) and the dam portion 33.

### DESCRIPTION OF THE REFERENCE NUMERALS

1: turbocharger, 2: plain bearing, 5: rotating portion, 20: bearing body, 21F: radial bearing portion, 21R: radial bearing portion, 22F: thrust bearing portion, 22R: thrust bearing portion, 23F: first damper portion (damper portion), 23R: first damper portion (damper portion), 24F: second damper portion (damper portion), 24R: second damper portion (damper portion), 25F: second groove portion, 25R: second groove portion, 27F: oil groove group, 27R: oil groove group, 29: inner diameter side recess, 30: oil hole, 31F: outer diameter side oil passage, 31R: outer diameter side oil passage, 32F: inner diameter side oil passage, 32R: inner diameter side oil passage, 33: dam portion, 33F: dam portion, 33R: dam portion, 34F: first groove portion (groove portion), 34R: first groove portion (groove portion), 35F: damper portion, 35R: damper portion, 36: third groove portion, 37: recess, 50: rotating shaft, 51: compressor impeller, 52: turbine impeller, 53: thrust collar, 90: bearing housing, 91: compressor housing, 92: turbine housing, 270F: oil groove, 270R: oil groove, 300: inlet, 301: outlet, 500: small diameter portion, 501: medium diameter portion, 502: large diameter portion, 503: stepped portion, 504: stepped portion, 900: bearing arrangement portion, 905: housing side oil passage (upstream side oil passage), 906: outlet, A: axis, B: pad portion, C: tapered portion, D: land portion, F: front end (axially outer end), H: front end (axially outer end), O: lubricating oil, f: oil film, h: altitude

1. A plain bearing, comprising:
a cylindrical bearing body;
a radial bearing portion arranged on an inner peripheral surface of the bearing body;
a thrust bearing portion arranged on an axial end surface of the bearing body;
a damper portion arranged on an outer peripheral surface of the bearing body;
a dam portion arranged on the outer peripheral surface of the bearing body; and
an oil hole having an inlet that opens to at least one of the outer peripheral surface of the bearing body and the dam portion, and an outlet that opens to the inner peripheral surface of the bearing body, wherein:
the inlet of the oil hole, at least a part of the dam portion, and the damper portion are arranged in this order from an axially inner side toward an axially outer side;
the outlet of an upstream side oil passage is connected to the inlet of the oil hole on a radially outer side;
an axially outer end of the outlet of the upstream side oil passage is arranged at the axially same position as an axially outer end of the dam portion, or arranged on an axially inner side with respect to the axially outer end of the dam portion; and
the dam portion has an annular shape centered on an axis of the bearing body.

2. (canceled)

3. The plain bearing according to claim 1, further comprising a groove portion that is arranged between the damper portion and the dam portion and has a diameter smaller than diameters of the damper portion and the dam portion.

4. (canceled)

5. A turbocharger comprising the plain bearing according to claim 1.
